(19) United States
(12) Patent Application Publication
(10) Pub. No.: US 2024/0265393 A1
(43) Pub. Date: Aug. 8, 2024

(54) SYSTEMS AND METHODS FOR UNIFIED USER EXPERIENCE WITH SINGLE SCREEN USER INTERFACE

(71) Applicant: Truist Bank, Charlotte, NC (US)

(72) Inventor: Prasad Prabhakarrao Jahagirdar, Fort Mill, SC (US)

(73) Assignee: Truist Bank, Charlotte, NC (US)

(21) Appl. No.: 18/164,704

(22) Filed: Feb. 6, 2023

(51) Int. Cl. G06Q 20/40; G06Q 20/02; G06Q 20/38; H04L 9/40

(52) U.S. Cl. CPC G06Q 20/4014; G06Q 20/023; G06Q 20/3821; H04L 63/105; G06Q 2220/00

(57) ABSTRACT

A system and method is disclosed for multi-level authorization to request, approve, and complete the processing of an interaction. The system receives a request to initiate dual approver services and generates a singular user interface. The system receives a first enrollment request for a first type of service and/or a second enrollment request for a second type of service. The first and/or second enrollment requests include a first, second, third, and fourth list of authorized users having, respectively, a first, second, third, and fourth level of authorization. The first and third list of authorized users select at least one of the first type of service and the second type of service for processing. The second and fourth list of authorized users then approve the selected service(s) for processing and the system completes the processing of the selected service(s).

### FIELD

This invention relates generally to the field of unified user experience, and more particularly, embodiments of the invention relate to providing a user a single graphical user interface experience for managing premium services requiring multi-level approval.

### BACKGROUND

Many companies include multi-level authorizations for certain types of activities the company may perform for security purposes. Having a second or higher level of authorization allows a company to avoid or deter fraudulent activity and scams that may occur if the requested activity is not double checked before it is executed or completed. Additional approval or authorization levels also help to prevent human error such as processing errors and even fraud within the company itself. However, current systems for ensuring the multi-level authorization is performed according to the company's policies can be cumbersome and require several different users to use various different systems that may impact the length of time before the activity is executed, leading to delays in processing and the potential for loss of business if a customer or client is impacted by the delay. Accordingly, a need exists for systems and methods for allowing a system to have a unified user experience with a single user interface for managing services that require multi-level approval.

### BRIEF SUMMARY

Embodiments of the present invention address the above needs and/or achieve other advantages by providing systems and methods to ensure users remain content with their user experience and are able to easily navigate the system without having to learn a new system.

Embodiments of the invention include a system for providing a unified user experience for multi-level authorization, the system including a first user computing device, a second user computing device, and an entity server. Each of the first user computing device, the second user computing device, and the entity server have at least one processor, a memory, and a communication device. The second user computing device is in communication with the first user computing device and the entity server is in communication with the first user computing device and the second user computing device. The entity server is configured to receive a request to initiate enrollment for dual approval services from the first user computing device. In response to receiving the request to initiate enrollment for dual approval services, the server generates a dual approval services user interface. The entity server is configured to receive a first enrollment request from the first user computing device for enrollment in a first type of service, wherein the first enrollment request includes a first list of users having credentials associated with a first level of authorization and a second list of users having credentials associated with a second level of authorization, where the first type of service is incorporated into the dual approval services user interface. The entity server is further configured to display the dual approval services user interface incorporating the first type of service on a first user interface associated with the first user computing device. The server receives user input through a user input device associated with the first user computing device selecting processing of the first type of service displayed on the dual approval services interface and then analyzes whether the user input came from a user having credentials associated with the first level of authorization. In response to determining that the user input came from a user having credentials associated with the first level of authorization, the selected first type of service is transmitted for processing to the second user computing device associated with at least one user having credentials associated with the second level of authorization. The system receives user approval through a second user input device associated with the second user computing device and, in response to receiving the user approval, the system completes the processing of the first type of service.

According to example embodiments of the invention, a method is disclosed for providing a unified user experience for multi-level authorization, the method including receiving a request to initiate enrollment for dual approval services from a first user computing device. In response to receiving the request to initiate enrollment for dual approval services, the method includes generating a dual approval services user interface. The method progresses by receiving an enrollment request from the first user computing device for enrolling in a first type of service, where the enrollment request includes a first list of users having a first level of authorization and a second list of users having a second level of authorization, and the first type of service is incorporated into the dual approval services user interface. The dual approval services user interface incorporating the first type of service is displayed on a first user interface associated with the first user computing device. The method continues by receiving user input through a user input device associated with the first user computing device, the user input including selecting processing of the first type of service displayed on the dual approval services user interface. The user input is analyzed to determine whether the user input came from a user having the first level of authorization. In response to determining that the user input came from a user having the first level of authorization, the method progresses by transmitting the selected first type of service for processing to a second user computing device associated with at least one user having the second level of authorization. After receiving user approval through a second user input device associated with the second user computing device, the method is finalized by completing processing of the first type of service.

Embodiments of the invention include a system for providing a unified user experience for multi-level authorization, the system including a first user computing device with at least one processor, a memory, and a communication device; a second user computing device with at least one processor, a memory, and a communication device, the second user computing device being in communication with the first user computing device; and an entity server with at least one processor, a memory, and a communication device, the entity server being in communication with the first user computing device and the second user computing device. The entity server is configured to receive a request to initiate enrollment for dual approval services from the first user computing device. In response to receiving the request to initiate enrollment for dual approval services, a dual approval services user interface is generated. The server then receives a first enrollment request from the first user computing device for enrolling in a first type of service, where the first enrollment request includes a first list of users having a first level of authorization and a second list of users having a second level of authorization, where the first type of service is incorporated into the dual approval services user interface. The server then receives a second enrollment request from the first user computing device for enrolling in a second type of service, where the second enrollment request includes a third list of users having a third level of authorization and a fourth list of users having a fourth level of authorization, where the second type of service is also incorporated into the dual approval services user interface. The system displays the dual approval services user interface incorporating the first type of service and the second type of service on a first user interface associated with the first computing device and receives user input through a user input device associated with the first user computing device selecting at least one of the first type of service and the second type of service. The system analyzes whether the user input came from a user having the first level of authorization, and in response to determining that the user input came from a user having the first level of authorization, the system transmits the selected at least one of the first type of service and the second type of service for processing to the second user computing device associated with at least one user having the second level of authorization. The system receives user approval through a second user input device associated with the second user computing device, and in response to receiving the user approval, the system completes the processing of at least one of the first type of service and the second type of service.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an enterprise system and environment thereof for providing a unified user experience for multi-level authorization, in accordance with an embodiment of the present invention.

FIG. 2A is a flowchart illustrating a method for providing a unified user experience using a single graphical user interface for multiple services requiring multiple levels of approval, according to at least one embodiment.

FIG. 2B is a continuation of the flowchart of FIG. 2A.

FIG. 3 illustrates an exemplary webpage or pop-up window that may be provided to a user when the user accesses a dual approval services user interface, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

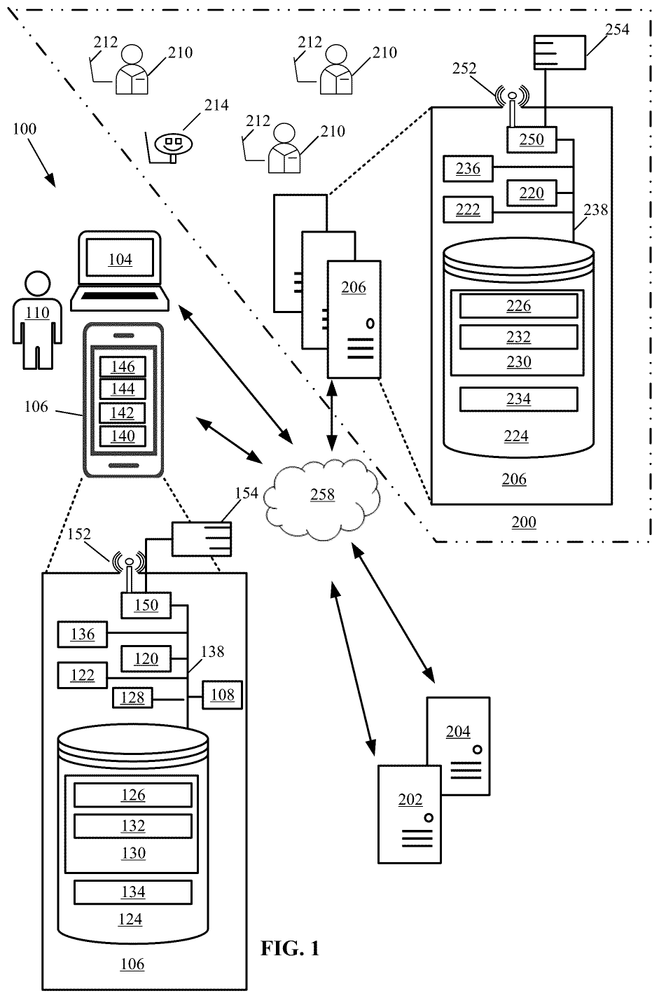

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be, for example, a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, a contactless communication device, and other transceivers. In addition, GPS (Global Positioning System) may be included for navigation and location-related data exchanges, ingoing and/or outgoing. Communications may also or alternatively be conducted via the connector 154 for wired connections such as by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may be utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the mobile device 104 and computing device 106, the agent devices 212, the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

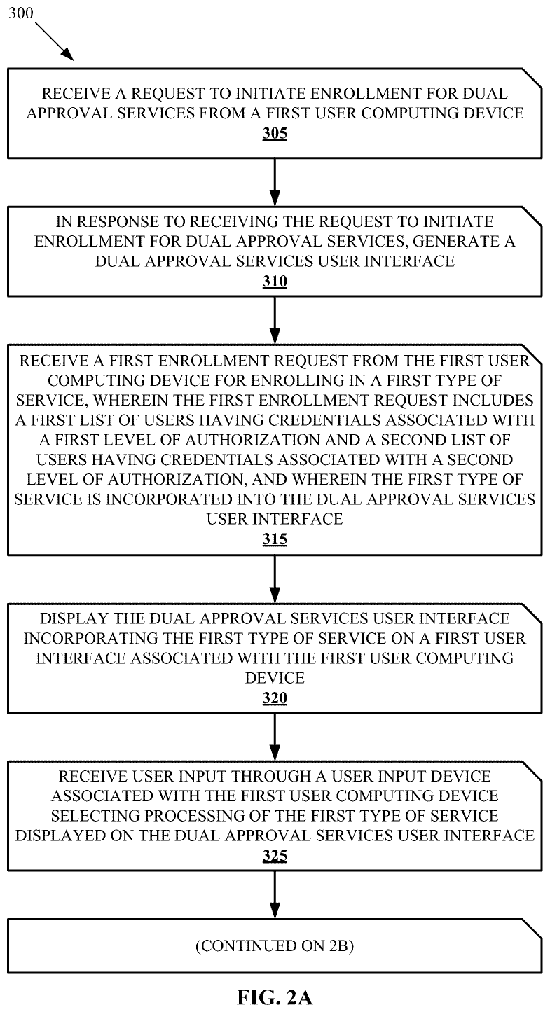

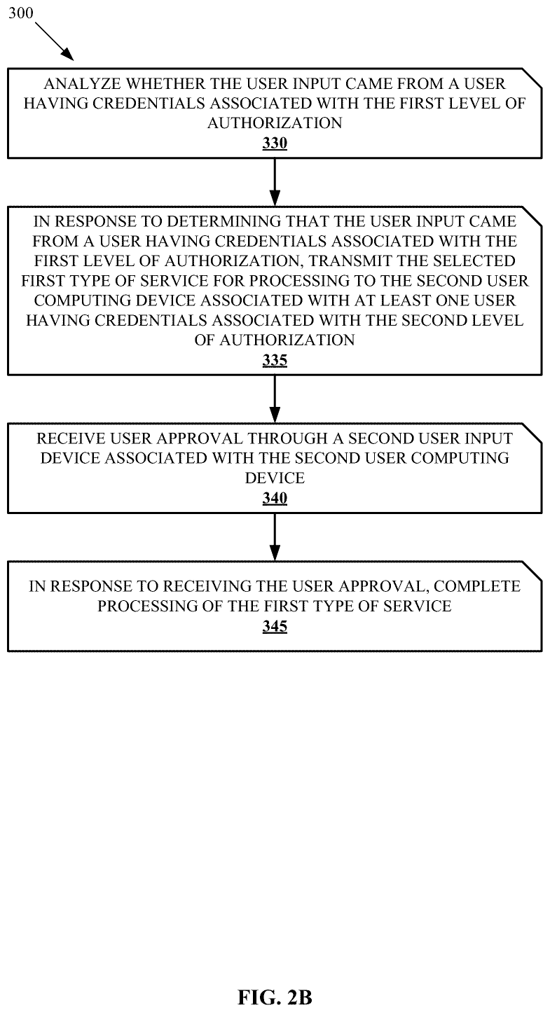

FIGS. 2A-2B depict a flow chart representing a system and method 300, according to at least one embodiment, for providing a unified user experience for multi-level authorization. In particular embodiments, the system 300 permits multi-level authorization for completing processing of an interaction for a first type of service and/or a second type of service that requires a first user having a first level of authorization to request processing of an interaction, and a second user having a second level of authorization for approving the requested processing of the interaction. The system generates a graphical user interface for dual approval services by using a single graphical user interface to display the first type of service and/or the second type of service on a single webpage for completing the processing of the interaction by the users.

The first step, as represented by block 305, is to receive a request to initiate enrollment for dual approval services from a first user computing device. In example embodiments, the system includes a first user computing device with at least one processor, a memory, and a communication device. A second user computing device in communication with the first user computing device also includes at least one processor, a memory, and a communication device. An entity server in communication with the first user computing device and the second user computing device also includes at least one processor, a memory, and a communication device. In particular embodiments, the first user computing device and/or the second user computing device includes any example computing device 104 or mobile device 106 listed above.

The request may be received from a web-based browser or dedicated application associated with an entity with which a user accessing the first user computing device holds at least one account or has another any other suitable form of relationship. For example, the user may be an employee of a business having a bank account with the entity, where the user is an authorized requestor or approver for various transactions or interactions involving the entity. In example embodiments, the entity is a financial institute or banking entity. In example embodiments, the at least one account is a bank account associated with a traditional resource or banking system. The user computing device, which may be a mobile device or non-mobile device, communicates with a back-end server system associated with the at least one account. The web-based browser is navigated to the online banking platform for the entity when it is a bank. The dedicated application may be a mobile application downloaded from an app store or other application hub for mobile devices.

In example embodiments, the request to initiate enrollment for dual approval services received from a first user computing device includes additional information regarding the user of the first user computing device. For example, the additional information may include that the user is customer or client of a particular banking entity. The additional information may further include certain attributes associated with the user type including the following identifiers for the user: (1) name; (2) phone number; (3) account number; (4) a code or other indicia denoting a level of authority or authorization for the user; and/or (5) other profile data. In particular embodiments, the user may be required to login to the web-based browser or dedicated application using either basic login credentials such as a username or password, or more advanced login credentials including biometric data, a personal identification number, and/or a two-step verification protocol. In various embodiments, once the login information has been received, the system will verify and authenticate the login information. A back-end server system may determine whether the submitted login information is sufficient to authenticate the user for access to the dual approval services system. If so, the system will generate and transmit a user authentication confirmation over the Internet to the first user computing device to grant the user access.

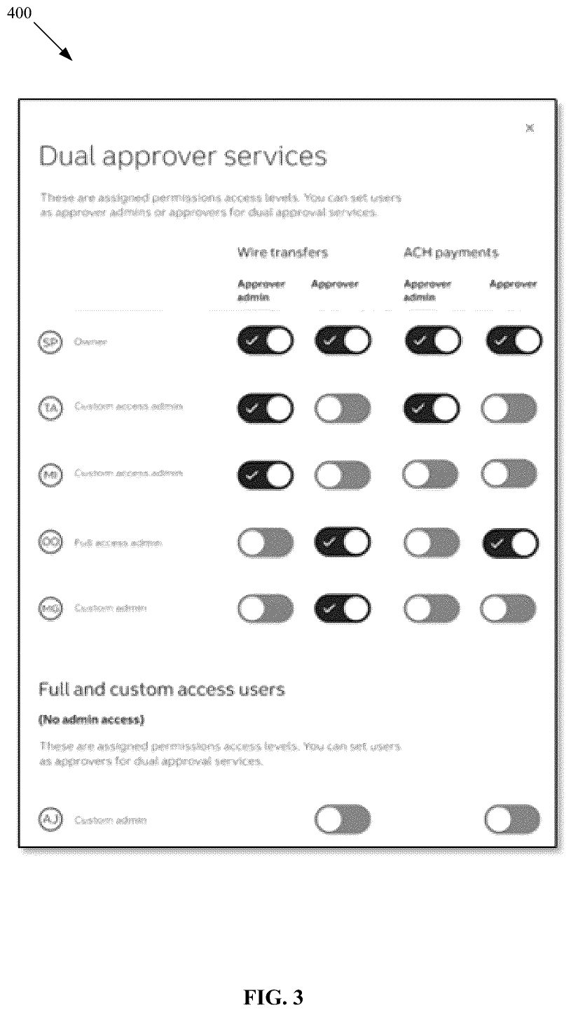

The next step, as represented by block 310, is to generate a dual approval services user interface in response to receiving the request to initiate enrollment for dual approval services. In example embodiments, the dual approval services user interface 400 is generated on a single webpage, as shown in FIG. 3. In example embodiments, any suitable graphical user interface may be created for displaying particular permissions allowed in the dual approver services system. In a particular embodiment, the dual approval services user interface includes at least a first type of service, in this case wire transfers, and a second type of service, in this instance ACH payments. In example embodiments, the service type may include any suitable service, interaction, transaction, or exchange such as online payment, wire transfer, ACH transfer or transaction, loan payment, mortgage payment, or any other online bill-pay. Where multiple services are included, the dual approval services user interface may have one or more columns for designating or assigning permission access levels and approval levels for each service type. For example, a user may be designated as a first-level, or approver admin for the first type of service. The same user may also be designated as a second-level or final approver for a second type of service. In some embodiments, a single user may be only approved for first-level access. In other embodiments, a single user may only be authorized for second-level access. In still other embodiments, a single user may be authorized for first-level access for a first type of service and second-level access for a second type of service, or vice versa. In example embodiments, the users are assigned permission levels by an authorized administrator for the company or entity with which the user is associated. Although shown as toggle selections, any suitable designation of permissions access levels may be used such as action buttons, drop-down options, checkboxes, and any other form field. In particular embodiments, where the user's title is displayed, the user's name or initials may also be incorporated into the dual approval services user interface. The dual approval services user interface may further include other employees or users that do not have any sort of administrative access to the dual approver services system. It should be understood that any designation of user access level may be implemented based on the parameters, factors, codes, or attributes that are received, selected by a user, or determined based on the type of computing device accessing the system and/or any user identifying information received from the user computing device.

In example embodiments, the dual approval services user interface 400 may be displayed as a single webpage or as a pop-up window over a particular webpage or website. In exemplar embodiments, the dual approval services user interface 400 uses the exact same, or substantially the same, graphical user interface for every type of user that has access to the dual approver services system. In particular embodiments, multiple users may simultaneously access the dual approver services system. In example embodiments, once the levels of permission and/or access are assigned to particular users, the system and method may proceed with completing various interactions and transactions requested on the dual approver services system according to the rules or permissions set on the dual approval services user interface. Although not shown, the dual approver services system may further include a second dual approval services user interface for receiving requested interactions and completing processing of the requested interaction based on the levels of permission assigned, as discussed further in the steps below.

Referring again to FIG. 2A and continuing to block 315, the method progresses by receiving a first enrollment request from the first user computing device for enrolling in a first type of service, where the first type of service is incorporated into the dual approval services user interface, as described above. When requesting the enrollment, a user may determine that they only need the first type of service (in this case wire transfers), but will not need access to the second type of service (i.e., ACH payments). Conversely, the user may determine that they only need the first type of service, but will not need the second type of service. Therefore, the first enrollment request may be limited to a single type of service. Included with the first enrollment request is also a first list of users having credentials associated with a first level of authorization and a second list of users having credentials associated with a second level of authorization.

In some embodiments, the system may also receive a second enrollment request from the first user computing device for enrolling in a second type of service, where the second type of service is also incorporated into the dual approval services user interface, as described above. Similarly, the user may only need the second type of service, but not the first, and therefore the second enrollment request may also be limited to a single type of service. A third and a fourth list of users associated with a third level of authorization and a fourth level of authorization, respectively, are included with the second enrollment request. In some embodiments, the first level of authorization is comparable to or at least partially includes some users from the third list of users having the third level of authorization while the second level of authorization, or the second level of users, is comparable to or at least partially includes some users from the fourth list of users having the fourth level of authorization. In particular embodiments, the first level of authorization is a lower level of authorization than the second level of authorization. For example, employees within a corporation may have different hierarchal positions within the organization where some employees are able to make certain requests, but then only certain other employees are able to confirm or approve the particular request. For example, an employee within the accounting department of a company may be allowed to request a wire payment sent to a particular vendor, but may require their manager or other supervisor to double check the transaction and then ultimately approve the wire payment be sent.

In example embodiments, in addition to receiving the list of users having the first, second, third, or fourth level of authorization, the system may further determine the user's level of authorization based on a variety of parameters and characteristics associated with the users' credentials received when the user submitted the initial request for dual approver services or when a user logs into the dual approver services system for requesting or approving an interaction. In example embodiments, the first and third list of users include a list of users that are considered interaction generators. For example, interaction generators are those users that generate or create the request to process the requested first and/or second type of service. In particular embodiments, the second and fourth list of users include a list of users that are considered interaction regulators. For example, interaction regulators are those users that approve or authorize the requested processing of the first and/or second type of service.

The method continues, at block 320, by displaying the dual approval services user interface incorporating at least the first type of service on a first user interface associated with the first user computing device. In embodiments where a user has selected the first and the second type of service, the dual approval services user interface will display both services on the same graphical user interface. In example embodiments, at block 325, after displaying the dual approval services user interface on the first user interface, the system receives user input through a user input device associated with the first user computing device. The user input includes a selection or request to process the first type of service displayed on the dual approval services user interface. In alternate embodiments, the user input may include a selection or request to process the second type of service displayed on the dual approval services user interface. In still further embodiments, the received user input may include selecting processing of the first type and the second type of service displayed on the dual approval services user interface.

Next, at block 330, in response to receiving the user input, the system analyzes whether the user input came from a user having credentials associated with the first level of authorization for requests to process the first type of service and/or whether the user input came from a user having the third level of authorization to process the second type of service. In response to determining that the user input came from a user having credentials associated with the first level of authorization and/or the third level of authorization, at block 335, the system transmits the selected first type of service and/or the second type of service for processing to the second user computing device associated with at least one user having credentials associated with the second level of authorization and/or at least one user having credentials associated with the fourth level of authorization.

Continuing to block 340, the system receives user approval through a second user input device associated with the second user computing device. In some embodiments, where the requested interaction involves both the first type of service and the second type of service, the system may receive a first user approval and a second user approval. In the alternative, the system may only receive one user approval or no approval at all if it is determined that the transaction is not yet ready for approval or completion of processing.

Finally, in response to receiving the user approval, at block 345, the system completes processing of the first type of service and/or the second type of service. The system will complete the processing according to the request(s) and approval(s) the system receives from the first user computing device and the second user computing device. In example embodiments, while described as a first and second user computing device, and number of computing devices may be used to access, request, and approve transactions/interactions through the dual approval services user interface via the dual approver services system.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A system for providing a unified user experience for multi-level authorization, the system comprising:
a first user computing device with at least one processor, a memory, and a communication device;
a second user computing device with at least one processor, a memory, and a communication device, the second user computing device being in communication with the first user computing device; and
an entity server with at least one processor, a memory, and a communication device, the entity server being in communication with the first user computing device and the second user computing device,
wherein the entity server is configured to:
receive a request to initiate enrollment for dual approval services from the first user computing device;
in response to receiving the request to initiate enrollment for dual approval services, generate a dual approval services user interface;
receive a first enrollment request from the first user computing device for enrolling in a first type of service, wherein the first enrollment request includes a first list of users having credentials associated with a first level of authorization and a second list of users having credentials associated with a second level of authorization, and wherein the first type of service is incorporated into the dual approval services user interface;
display the dual approval services user interface incorporating the first type of service on a first user interface associated with the first user computing device;
receive user input through a user input device associated with the first user computing device selecting processing of the first type of service displayed on the dual approval services user interface;
analyze whether the user input came from a user having credentials associated with the first level of authorization;
in response to determining that the user input came from a user having credentials associated with the first level of authorization, transmit the selected first type of service for processing to the second user computing device associated with at least one user having credentials associated with the second level of authorization;
receive user approval through a second user input device associated with the second user computing device;
in response to receiving the user approval, complete processing of the first type of service.

2. The system of claim 1, wherein the first type of service is at least one of a wire transfer service and an ACH transfer service.

3. The system of claim 1, wherein the entity server is further configured to:
receive a second enrollment request from the first user computing device for enrolling in a second type of service, wherein the second enrollment request includes a third list of users having a third level of authorization and a fourth list of users having a fourth level of authorization, and wherein the second type of service is incorporated into the dual approval services user interface.

4. The system of claim 3, wherein the entity server is further configured to:
display the dual approval services user interface incorporating the second type of service on a third user interface associated with a third computing device;
receive user input through a third user input device associated with the third user computing device selecting processing of the second type of service displayed on the dual approval services interface;
analyze whether the user input came from a user having the third level of authorization;
in response to determining that the user input came from a user having the third level of authorization, transmit the selected second type of service for processing to a fourth user computing device associated with at least one user having the fourth level of authorization;
receive user approval through a fourth user input device associated with the fourth user computing device;
in response to receiving the user approval, complete processing of the second type of service.

5. The system of claim 4, wherein the second type of service is at least one of a wire transfer service and an ACH transfer service.

6. The system of claim 3, wherein the first list of users at least partially includes the third list of users.

7. The system of claim 3, wherein the second list of users at least partially includes the fourth list of users.

8. A method for providing a unified user experience for multi-level authorization, the method comprising:
receiving a request to initiate enrollment for dual approval services from a first user computing device;
in response to receiving the request to initiate enrollment for dual approval services, generating a dual approval services user interface;
receiving an enrollment request from the first user computing device for enrolling in a first type of service, wherein the enrollment request includes a first list of users having a first level of authorization and a second list of users having a second level of authorization, and wherein the first type of service is incorporated into the dual approval services user interface;
displaying the dual approval services user interface incorporating the first type of service on a first user interface associated with the first user computing device;
receiving user input through a user input device associated with the first user computing device selecting processing of the first type of service displayed on the dual approval services user interface;
analyzing whether the user input came from a user having the first level of authorization;
in response to determining that the user input came from a user having the first level of authorization, transmitting the selected first type of service for processing to a second user computing device associated with at least one user having the second level of authorization;
receiving user approval through a second user input device associated with the second user computing device;
in response to receiving the user approval, completing processing of the first type of service.

9. The method of claim 8, wherein the first level of authorization comprises a lower level of authorization than the second level of authorization.

10. The method of claim 8, wherein at least one of the first list of users and the third list of users comprises a list of interaction generators, wherein the interaction generators are authorized to request processing of the first type of service.

11. The method of claim 8, wherein at least one of the second list of users and the fourth list of users comprises a list of interaction regulators, wherein the interaction regulators are authorized to approve processing of the first type of service.

12. The method of claim 8, wherein:
the first user computing device comprises at least one processor, a memory, and communication device; and
the second user computing device comprises at least one processor, a memory, and a communication device.

13. The method of claim 8, the method further comprising:
receiving a second enrollment request from the first user computing device for enrolling in a second type of service, wherein the second enrollment request includes a third list of users having a third level of authorization and a fourth list of users having a fourth level of authorization, and wherein the second type of service is incorporated into the dual approval services user interface.

14. The method of claim 8, the method further comprising:
displaying the dual approval services user interface incorporating the second type of service on a third user interface associated with a third computing device;
receiving user input through a third user input device associated with the third user computing device selecting processing of the second type of service displayed on the dual approval services interface;
analyzing whether the user input came from a user having the third level of authorization;
in response to determining that the user input came from a user having the third level of authorization, transmitting the selected second type of service for processing to a fourth user computing device associated with at least one user having the fourth level of authorization;
receiving user approval through a fourth user input device associated with the fourth user computing device;
in response to receiving the user approval, completing the processing of the second type of service.

15. The method of claim 8, wherein the first type of service is at least one of a wire transfer service and an ACH transfer service.

16. A system for providing a unified user experience for multi-level authorization, the system comprising:
a first user computing device with at least one processor, a memory, and a communication device;
a second user computing device with at least one processor, a memory, and a communication device, the second user computing device being in communication with the first user computing device; and
an entity server with at least one processor, a memory, and a communication device, the entity server being in communication with the first user computing device and the second user computing device,
wherein the entity server is configured to:
receive a request to initiate enrollment for dual approval services from the first user computing device;
in response to receiving the request to initiate enrollment for dual approval services, generate a dual approval services user interface;
receive a first enrollment request from the first user computing device for enrolling in a first type of service, wherein the first enrollment request includes a first list of users having a first level of authorization and a second list of users having a second level of authorization, and wherein the first type of service is incorporated into the dual approval services user interface;
receive a second enrollment request from the first user computing device for enrolling in a second type of service, wherein the second enrollment request includes a third list of users having a third level of authorization and a fourth list of users having a fourth level of authorization, and wherein the second type of service is incorporated into the dual approval services user interface;
display the dual approval services user interface incorporating the first type of service and the second type of service on a first user interface associated with the first computing device;
receive user input through a user input device associated with the first user computing device selecting at least one of the first type of service and the second type of service;
analyze whether the user input came from a user having the first level of authorization;
in response to determining that the user input came from a user having the first level of authorization, transmit the selected at least one of the first type of service and the second type of service for processing to the second user computing device associated with at least one user having the second level of authorization;
receive user approval through a second user input device associated with the second user computing device;
in response to receiving the user approval, complete processing of at least one of the first type of service and the second type of service.

17. The system of claim 16, wherein the first level of authorization and the third level of authorization each comprises authority to request processing of at least one of the first type of service and the second type of service, and the second level of authorization and the fourth level of authorization each comprises authority to approve processing of at least one of the first type of service and the second type of service.

18. The system of claim 16, wherein the first type of service comprises a wire transfer service and the second type of service comprises an ACH transfer service.

19. The system of claim 16, wherein the first list of users at least partially includes the third list of users.

20. The system of claim 16, wherein the second list of users at least partially includes the fourth list of users.
